(19) United States
(12) Patent Application Publication
(10) Pub. No.: US 2013/0035821 A1
(43) Pub. Date: Feb. 7, 2013

(54) DRIVING ASSISTANCE APPARATUS FOR ASSISTANCE WITH DRIVING ALONG NARROW ROADWAYS

(71) Applicants: Uwe BONNE, Buettelborn (DE); Marco MOEBUS, Mainz (DE); Markus ARMBRUST, Wonsheim (DE)

(72) Inventors: Uwe BONNE, Buettelborn (DE); Marco MOEBUS, Mainz (DE); Markus ARMBRUST, Wonsheim (DE)

(73) Assignee: GM GLOBAL TECHNOLOGY OPERATIONS LLC, Detroit, MI (US)

(21) Appl. No.: 13/567,637

(22) Filed: Aug. 6, 2012

(30) Foreign Application Priority Data
Aug. 4, 2011 (DE) 10 2011 109 492.3

(51) Int. Cl. B60W 30/06

(52) U.S. Cl. 701/25

(57) ABSTRACT

A driving assistance apparatus for a motor vehicle for assistance with driving along narrow roadways is provided. The apparatus includes a data acquisition unit for acquiring route data on the route to be obtained from wheel and steering angle sensors, a trajectory storage unit for recording the route data of the data acquisition unit, and a triggering unit for triggering the motor vehicle on a basis of the data recorded route data recorded by the trajectory storage unit. A satellite navigation unit determines an absolute position of the motor vehicle and digital map data with position attribute data for checking whether the motor vehicle is located in a vicinity of road areas with restricted scope for navigation and in such a case suggests recording of a trajectory to a driver of the motor vehicle or executes the recording of the trajectory in an automated manner.

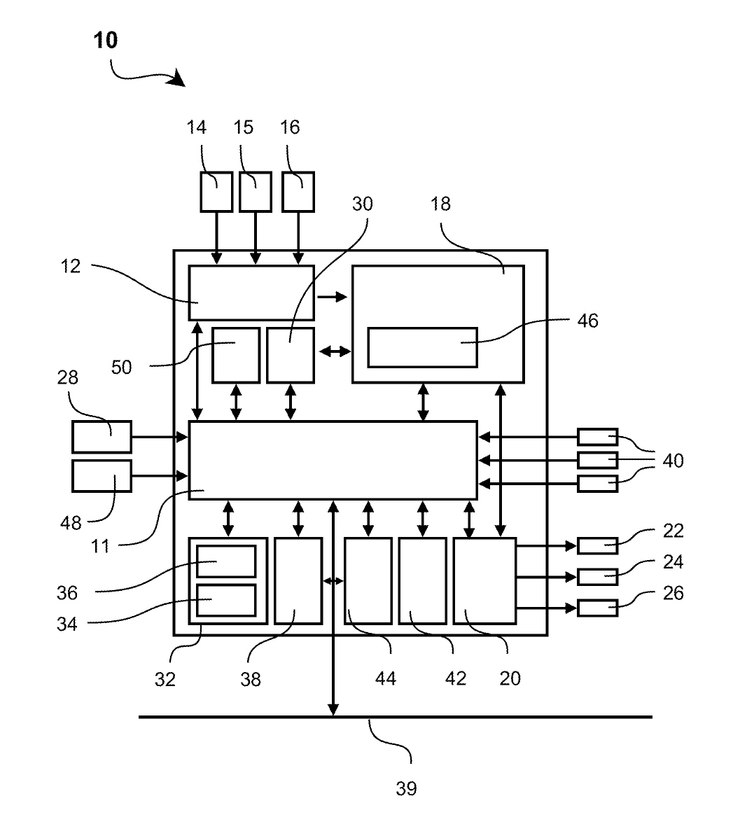

### CROSS-REFERENCE TO RELATED APPLICATION

This application claims priority to German Patent Application No. 10 2011 109 492.3, filed Aug. 4, 2011, which is incorporated herein by reference in its entirety.

### TECHNICAL FIELD

The technical field relates to a driving assistance apparatus for a motor vehicle for assistance with driving along narrow roadways, comprising a data acquisition unit for acquiring data on the route to be covered from wheel and steering angle sensors, and a storage unit for recording the route data as well as a triggering unit for triggering the motor vehicle on the basis of the recorded route data, for driving along the recorded route in the same or reverse direction.

### BACKGROUND

A generic driving assistance apparatus is known from EP 1 858 744 B1, in which short path trajectories of about 5 meters (m) traveled by the vehicle concerned and determined by wheel and steering angle sensors are recorded and are available for automated or partially automated driving in the same or reverse direction so that it is possible to drive along narrow road areas, for example, entrances into garages or exits from such under confined conditions. A disadvantage here is that the recorded trajectory is actually valid from a certain starting point, which, however, is not definable. For example, the path trajectory is recorded when the vehicle is standing in front of a parking space (or a garage). If however the vehicle is standing at a different location at a later time point and the automatic parking is started, this can have the result that the driving in process cannot be executed, in particular if the starting state is laterally offset or further away from the starting state in the recording process.

Another driving assistance apparatus is known from DE 196 35 892 A1. This makes it easier to park under confined conditions. In this case, firmly stored optimized driving trajectories (so-called model driving data) which were determined with the assistance of an experienced driver are taken as the basis. In this way, the vehicle can be moved automatically and without the intervention of the possibly inexperienced driver into the parking space. This apparatus requires a selection of stored typical parking situations and is not able to take account of special actual circumstances (e.g. curbstones or posts), which make the parking process difficult in the particular case.

It is at least one object herein to configure a driving assistance apparatus to be substantially more flexible to enable a parking process under substantially more different conditions than was possible hitherto. In addition, other objects, desirable features and characteristics will become apparent from the subsequent summary and detailed description, and the appended claims, taken in conjunction with the accompanying drawings and this background.

### SUMMARY

A driving assistance apparatus for a motor vehicle for assistance with driving along narrow roadways is provided. The driving assistance apparatus includes a data acquisition unit for acquiring data on the route (trajectory) to be covered from wheel and steering angle sensors, and a trajectory storage unit for recording the route data as well as a triggering unit for triggering the motor vehicle on the basis of the recorded route data, for driving along the recorded route in the same or reverse direction. A satellite navigation unit is provided for determining the absolute position of the motor vehicle as well as digital map data with position attribute data for checking whether the motor vehicle is located in the vicinity of road areas with restricted scope for navigation and in such a case suggests the recording of a trajectory to the driver or executes this in an automated manner.

In this regard, in many driving situations the driver does not need to worry about whether the route to be driven should be recorded as a trajectory but on the contrary when typical situations arise which indicate a trajectory recording, this is suggested or executed automatically. This is because specifically when driving in areas having restricted scope for navigation, the driver must typically concentrate on the driving process and the surroundings and then does not think about making a trajectory recording. Such a situation arises particularly when driving in parking garages, parking spaces, or blind alleys.

According to an embodiment, the driving assistance apparatus comprises environmental detection sensors, by which the environmental data can be recorded when driving along the route and a storage device stores the environmental data for the corresponding route data. The environmental detection sensors are preferably optical sensors. Alternatively or additionally, the environmental detection sensors can also comprise other types of sensors, in particular ultrasound, lidar, or radar devices. Furthermore, an image processing unit is provided, which creates object data of objects located in the vicinity of the route by the environmental data, wherein the storage device stores the object data on the corresponding route data. The environment of the trajectory is thus co-recorded and provides more accurate information on the route course so that in particular more degrees of freedom are opened up when repeatedly driving along the trajectory. It can thus be determined whether a lateral offset to the stored trajectory can readily be driven or as a result of particular obstacles (e.g. curbstones, posts), a precise driving along the trajectory is required. Preferably curbstone sensors can be provided for this purpose, which take into account the course of curbstones disposed in the vicinity of trajectories.

According to another embodiment, the driving assistance apparatus comprises an environmental data matching unit, which matches object data determined by the environmental detection sensors with the environmental data determined by the digital map unit. In this way, the virtual trajectory environment image is further refined so that, for example, objects located temporarily in the vicinity such as persons or parked bicycles/prams can be appropriately taken into account as such.

According to a further embodiment, a position approach signal can be supplied to a driver communication unit, which provides the driver with the possibility for activating an automatic driving of the corresponding route and optionally, when the driver decides on this, activates the triggering unit for autonomous driving of the route by the motor vehicle. The driver therefore does not need to worry whether specific trajectories are recorded or he need not interactively select the desired trajectory from a plurality of stored trajectories but this is done for him by the system. The driving assistance apparatus therefore makes it considerably easier to operate the system since he no longer needs to consider whether a trajectory is stored or not. Preferably the approach to a recorded trajectory can be signaled to him so that initially a manual triggering is possible. When sufficiently close, an automatic driving into the trajectory and subsequent driving along the same can be proposed and executed if the driver is in agreement.

According to an embodiment, the storage device comprises an additional circular buffer region, for example in the form of a RAM, which stores the route data during motion of the motor vehicle and, if these are co-recorded, additionally the environmental data and/or the object data and for this deletes the oldest data in each case. Consequently, a trajectory of the route last covered is available at any time, which can either be stored permanently for future use if the driver desires this or this can be used immediately if this route is to be driven back

The driving assistance apparatus communicates with a driver identification unit and in the storage device the route data and the additional data stored for this purpose are stored for each driver, according to another embodiment. If an approach to stored trajectories is then examined subsequently, either the trajectories assigned to this can be suggested to the driver or for each trajectory it is signaled whether these originate from him or other persons. It can thus be prevented that trajectories to be assigned to inexperienced drivers are suggested to experienced drivers.

According to a further embodiment, the driving assistance apparatus comprises a trajectory introducing unit which determines a suitable route on which the motor vehicle can be moved in a selected trajectory. Such a trajectory introducing unit determines by the position and alignment of the motor vehicle and the trajectory data a shortest possible route on which the vehicle is guided on the trajectory and can then be moved further along the trajectory.

According to an embodiment, boundary value position data at the time of commencement and/or end of the route can be determined by a satellite navigation receiver and the storage unit stores the boundary value position data for the route data. An approach checking unit is further provided, which checks whether the motor vehicle is approaching the stored route commencement or end and in this case generates a position approach signal. When recording the trajectory data, available inertial sensors, in particular signals of a yaw rate sensor, are used to increase the accuracy.

Because absolute position data are stored for each stored route (trajectory), the system can on the one hand determine whether the vehicle is located in the vicinity of a stored trajectory. The position approach signal produced in this case can preferably be used to suggest automatic driving along the trajectory to the driver. On the other hand, by a comparison of the current position with the stored boundary value position data, it can be determined whether the vehicle is located sufficiently close to a recorded trajectory so that the vehicle can be driven along automatically or initially - preferably automatically—so that the vehicle can be moved to the trajectory in order to then drive along this.

The driving assistance apparatus comprises a time unit in order to store the recording time for each trajectory recording, according to an embodiment. Consequently, when selecting a plurality of available trajectories, a suggestion or a weighting can be made according to the actual clock time. If a trajectory was recorded in the evening, for example, on approaching, such a trajectory recorded in the evening can be suggested preferentially over a trajectory recorded in the morning. This is because in the evening a driver will tend to want to park in the garage and over the day in front of the house.

According to another embodiment, the driving assistance apparatus can be acted upon by a trailer signal that indicates whether the vehicle is towing a trailer in the trajectory recording and this trailer signal can be stored for each trajectory recording. Consequently, a trajectory can preferentially be suggested to the driver which covers the same conditions, that is specifically if a trailer is being towed, a trajectory recorded with trailer and conversely.

According to an embodiment, the driving assistance apparatus comprises a digital map unit which contains the digital map data. In this way, the driving assistance apparatus can operate completely independently.

According to a further embodiment, the driving assistance apparatus comprises a wireless telecommunications device for reloading the digital map data. In this case, data stored in the digital map unit can be updated. This is primarily advantageous in order to have up-to-date street data still available after a few years, that is, in somewhat older motor vehicles. Alternatively, the locally required digital map data can be loaded by the telecommunications device.

### BRIEF DESCRIPTION OF THE DRAWINGS

The various embodiments will hereinafter be described in conjunction with the following drawing figures, wherein like numerals denote like elements, and wherein:

The FIGURE shows a schematic diagram of a driving assistance apparatus in accordance with an exemplary embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

The FIGURE illustrates an exemplary driving assistance apparatus 10 including a central data processing unit 11 for controlling processes described below. The driving assistance apparatus also has a data acquisition unit 12, which is connected to a plurality of sensors, in particular wheel sensors 14, a yaw rate sensor 15, and a steering angle sensor 16 in order to determine route data of a route (trajectory) to be covered on the basis of the sensor signals. These route data are then stored in a trajectory storage unit 18. The driving assistance apparatus 10 further comprises a triggering unit 20, which brings about a triggering of the motor vehicle (not shown) on the basis of the trajectories stored in the trajectory storage unit 18, in particular by controlling a vehicle steering device 22, a vehicle gear shift 24, and a gas pedal 26. The motor vehicle is thus in a position to automatically drive along the route of an arbitrary trajectory stored in the trajectory storage unit 18 and, specifically controlled by the data processing unit 11, either in the recorded or the reverse direction of travel.

In an embodiment, the driving assistance apparatus 10 is connected to a satellite navigation receiver 28, which is preferably configured as a GPS or Galileo receiver or similar in order to deliver absolute position data (relative to an Earth coordinate system such as WSG 84) of the motor vehicle whereabouts. The data processing unit 11 stores the absolute position data at least for the initial and end value of each trajectory so that the absolute position data can thus be determined at each point of the trajectory. In an embodiment, the absolute position value of the satellite navigation receiver 28 is expediently only used for one boundary value and the second boundary value is calculated from this by means of the route data since the accuracy of the satellite navigation determination is considerably lower than the position data determined by the sensors 14, 16 and therefore the calculation of the second boundary value leads to a more conclusive result than if both boundary values are determined from satellite navigation data.

Alternatively the absolute position data can be co-recorded for each route point which, however, is meaningful if the satellite navigation receiver 28 provides sufficiently accurate position data, for example by differential GPS.

In another embodiment, the driving assistance apparatus 10 further comprises an approach checking unit 30, which during the journey permanently compares the current position signal of the satellite navigation receiver 28 with the boundary value position data stored in the trajectory storage unit 18 and checks whether the distance from one of the boundary value position data is below a stipulated threshold value, for example, 20 m or 100 m. If this is the case, the approach checking unit 30 produces a position approach signal that is processed by the data processing unit 11.

In a further embodiment, the driving assistance apparatus 10 comprises a driver communication unit 32, which comprises one or more optical and/or acoustic and/or haptic signaling units 34, in order to signal specific events to the driver and at least one haptic and/or acoustic input unit 36 for the driver, by which the driver communicates with the driving assistance apparatus 10. The afore-mentioned position approach signal is thus output to the driver via signaling units 34, for example, by text output on a display and simultaneous output of an announcement text - similar to the announcement texts of a navigation device - via loudspeaker. The driver can then decide whether the trajectory should be driven along and activate a corresponding input unit 36, for example, by pressing a button or speaking a word, that can be analyzed by means of the data processing unit 11.

The driving assistance apparatus 10 further comprises a digital map unit 38, in which information about road topology and road class data are stored, according to an embodiment. Alternatively, this unit receives the map data from other sources, preferably via a CAN interface or via another communication channel. Road class data is understood as information about whether a road is a freeway, expressway, a parking space, or a blind alley. The map data can thus originate from other data sources inside the vehicle, for example, a navigation system, or external road information or road class data can be loaded via external environmental communication channels. Communication with the digital map unit 38 is preferably accomplished via a CAN bus system (controller area network) 39 of the vehicle.

Further, the digital map unit 38 preferably additionally contains environmental data, e.g. of buildings or similar obstacles. By reference to this road class data, the data processing unit 11 can check whether a route recording is suggested to the driver or introduced automatically.

In another embodiment, the driving assistance apparatus 10 is further coupled to environmental detection sensors 40 such as are provided in modern motor vehicles, in particular image recording and/or ultrasound sensors. If image recording devices are used, the data processing unit 11 is coupled to an image processing unit 42, which can detect objects in the surroundings and creates corresponding object data, which are preferably also deposited in the trajectory storage unit 18 and can be used when determining suitable road ways deviating slightly from the stored trajectory. The environmental detection sensors 40 can also comprise weather sensors (outside temperature, outside humidity sensors). Thus, the driver can be offered a suitable trajectory depending on the weather (e.g. in rain or snowfall, a trajectory leading to a garage space would be preferentially proposed over a road parking space).

The environmental detection sensors 40 can further comprise a trailer sensor by which it is determined whether a trailer is suspended on a trailer coupling provided. This information would then be co-stored when recording a trajectory.

In a further embodiment, the driving assistance apparatus 10 further comprises an environmental data matching unit 44 which matches object data determined by the environmental detection sensors 40 by the image processing unit 42 with the object data located in the digital map unit 38 in order to produce a correct image of the surroundings which is then stored for the route data.

The trajectory storage unit 18 provided in the driving assistance apparatus 10 comprises a circular buffer region 46, which records the current position data automatically or in response to express driver instruction and overwrites the oldest data. Thus, a certain section of the route last covered is available for permanent storage.

In an embodiment, the preferred driving assistance apparatus 10 further communicates with a driver identification unit 48, which produces its own identification signal for each driver, for example, by means of an RFID tag provided in the ignition key. By means of this information, the data processing or the information output to the driver can be accomplished depending on the person.

In another embodiment, the driving assistance apparatus 10 further comprises a trajectory introducing unit 50 that determines by reference to the current absolute position data determined by means of the satellite navigation receiver 28 an optimal route from a position lying not on a stored trajectory taking into account stored object data to arrive at a specific trajectory without touching obstacles.

An embodiment of the storage of routes/trajectories is now described. While the vehicle fitted with the driving assistance apparatus 10 moves, it is permanently checked by the satellite navigation receiver 28 in conjunction with the position data located in the digital map unit 38 and the position attribute data pertaining thereto whether the vehicle is located at a place that has restricted scope for navigation. If this is not the case, nothing happens. If this is the case, on the other hand, in one embodiment this situation is signaled to the driver via the driver communication unit 32, for example, via a special information tone in conjunction with a visually displayed question or via an acoustically transmitted question and the request to signal whether a recording should take place, for example, by pressing a button or a spoken answer recorded by the system, e.g. “yes” or “no”. In a second embodiment, a trajectory recording is made automatically, where this circumstance can be displayed visually or audibly to the driver via the driver communication unit 32. If the vehicle then comes to a standstill at some point during the recording, the driver is asked whether this trajectory should be stored permanently, that is for future uses. In each case, this most up-to-date trajectory can be retrieved as required, in particular if the vehicle was driven into a parking space and is to be maneuvered out from this again at a later time point. If a trajectory recording was commenced automatically, this is preferably interrupted when the driving assistance apparatus 10 determines that the vehicle is no longer located at a place with restricted scope for navigation or the driving speed reaches a /value at which a parking process is improbable (e.g. faster than 40 km/h).

If a trajectory recording takes place, whether this be at the command of the driver or automatically, the data processing unit 11 reads the current absolute position data from the satellite navigation receiver 28 and stores this in the trajectory storage unit 18. Further, the clock time and the date of the recording are preferably stored. The further vehicle movements brought about by the driver are recorded at least by the wheel sensors 14 and the steering angle sensor 16 and the inertial measurement technique. Other sensors provided in the vehicle which record the gas pedal position or the gear shift position can further be read out. Route data are calculated cyclically from this, which are stored in the trajectory storage unit 18 for the trajectory concerned.

Information about the environment is further determined by the environmental detection sensors 40, evaluated in the image processing unit 42, and environmental data about objects and obstacles in the surroundings of the trajectory are determined from this and from the data of the digital map unit 38 and likewise stored in the trajectory storage unit 18. When the vehicle comes to a standstill, the data recording is ended and the trajectory deposited permanently in the trajectory storage unit 18. The driver can be asked beforehand via the driver communication unit 32 whether the trajectory should actually be stored permanently. Further, the stored route/trajectory is preferably provided with a driver identification mark from the driver identification unit 48 in order to assign this to the driver concerned. It is also possible to offer the driver the possibility via the driver communication unit 32 to designate the stored trajectory (e.g. “home garage”) manually by buttons or by speech input. A typical stored route/trajectory has a length of about 5 to 100 m.

In this or similar manner a plurality of routes or trajectories can be recorded in the course of time and stored in the trajectory storage unit 18.

For use of the stored trajectories during the journey the approach checking unit 30 checks the stored trajectories to determine whether the vehicle is approaching a boundary value (initial or end value) of one of the stored routes. If this is the case and one distance value is exceeded (possibly adjustable by the user), a position approach signal is produced. The data processing unit 11 then initially checks whether further stored trajectories exist that lie spatially in the vicinity of the trajectory concerned. For example, a plurality of alternative approach routes to a parking space (e.g. with or without trailer) or a plurality of alternative parking spaces (e.g. in a garage or in an inner courtyard or on the street). Now, the one trajectory or, if several are possible, all the possible trajectories are signaled to the driver via the driver communication unit 32, for example by speech output and display. This signaling can be made dependent on the driving speed, e.g., only when the vehicle is stationary or traveling at a low speed (e.g. less than 5 km/h) because with a faster traveling vehicle it is unlikely that the driver wishes to drive into a parking space etc.

If the driver signals via the driver communication unit 32 that he is going to drive along the trajectory concerned or selects one trajectory when several are possible, the data processing unit 11 will activate the triggering unit 20, which by the data retrieved from the trajectory storage unit 18 causes the vehicle to drive along the trajectory. If the vehicle is not yet located on the trajectory at this time, a suitable route is determined in advance by the trajectory introducing unit 50 and driven along in order to move the vehicle automatically on the trajectory route. The driver always has the possibility for intervention in the movement process.

When selecting a trajectory, the driver can be offered the possibility via the driver communication unit 32 to input end point deviations in order, for example, to allow accessibility to the trunk or to passenger doors. If the driver wishes the trunk to be accessible, the parking position would be shifted forward depending on signals of the environmental detection sensors 40, so that sufficient space remains behind the vehicle. Accordingly, for accessibility of the front passenger door, the end position would be shifted more to the left depending on the signals of the environmental detection sensors 40.

As noted above, a trailer sensor signal can also be stored. When making the choice of trajectory, it can then be examined whether the vehicle is currently towing a trailer and then trajectories having the same conditions are preferentially suggested. When selecting a trajectory recorded without a trailer, a correction to the course to be driven can alternatively be made by the data processing unit 11 in order to allow for cornering of a trailer.

With use of the driving assistance apparatus 10, it is not only easier to drive into narrow garages or parking spaces but also to drive over longer areas such as blind alleys or narrow lanes in old localities. For example, maneuvering in narrow rear courtyards requiring driving forward and in reverse many time can be made easier. It is naturally also possible to achieve activation by means of remote control so that the driver can leave the vehicle before driving along the trajectory.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A driving assistance apparatus for a motor vehicle for assistance with driving along narrow roadways, the driving assistance apparatus comprising:
a data acquisition unit configured for acquiring route data on a route to be obtained from wheel and steering angle sensors;
a trajectory storage unit configured for recording the route data of the data acquisition unit;
a triggering unit configured for triggering the motor vehicle on a basis of the route data recorded by the trajectory storage unit, for driving along the route in the same or reverse direction;
a satellite navigation unit configured for determining an absolute position of the motor vehicle and digital map data with position attribute data for checking whether the motor vehicle is located in a vicinity of road areas with restricted scope for navigation and in such a case suggests recording of a trajectory to a driver of the motor vehicle or executes the recording of the trajectory in an automated manner.

2. The driving assistance apparatus according to claim 1, further comprising environmental detection sensors configured for recording environmental data when driving along the route and wherein a storage device stores the environmental data for corresponding route data.

3. The driving assistance apparatus according to claim 2, wherein boundary value position data at a time of a commencement and/or end of the route is determined by the satellite navigation unit and the storage device stores the boundary value position data for the route data and further comprising an approach checking unit configured to check whether the motor vehicle is approaching the commencement or end of the route stored and to generate a position approach signal of the motor vehicle is approaching the commencement or end of the route stored.

4. The driving assistance apparatus according to claim 2, wherein the driving assistance apparatus communicates with a driver identification unit and wherein, in the storage device, individual route data is stored for an individual driver and, when specific states arise, the individual route data stored for the individual driver is retrieved.

5. The driving assistance apparatus according to claim 2, wherein the environmental detection sensors comprise optical sensors and further comprising an image processing unit configured to create object data of objects located in a vicinity of the route by the environmental data, wherein the storage device stores the object data on the corresponding route data.

6. The driving assistance apparatus according to claim 5, further comprising a digital map unit that contains the digital map data.

7. The driving assistance apparatus according to claim 6, further comprising a wireless telecommunications device for reloading the digital map data.

8. The driving assistance apparatus according to claim 7, further comprising an environmental data matching unit configured to match object data determined by the environmental detection sensors with the environmental data determined by the digital map unit.

9. The driving assistance apparatus according to claim 5, wherein the trajectory storage unit comprises an additional circular buffer region configured to store the route data during motion of the motor vehicle and optionally additionally the environmental data and/or the object data and deletes oldest data in each case.

10. The driving assistance apparatus according to claim 2, wherein the environmental detection sensors further comprise a trailer sensor configured to produce a trailer signal that indicates whether the motor vehicle is towing a trailer in a route recording and wherein the trailer signal is stored when recording a route.

11. The driving assistance apparatus according to claim 1, wherein a position approach signal is supplied to a driver communication unit, which provides the driver of the motor vehicle with an option for activating an automatic driving of a corresponding route and optionally activates the triggering unit for autonomous driving of the route by the motor vehicle.

12. The driving assistance apparatus according to claim 1, further comprising a trajectory introducing unit that is configured to determine a suitable route on which the motor vehicle can be moved in a selected trajectory.

13. The driving assistance apparatus according to claim 1, further comprising a time unit configured to store a recording time for the route recorded.
